(19) United States
(12) Patent Application Publication
(10) Pub. No.: US 2026/0134518 A1
(43) Pub. Date: May 14, 2026

(54) SYSTEMS AND METHODS FOR MOTION-CONTROLLABLE VIDEO DIFFUSION

(71) Applicant: Netflix, Inc., Los Gatos, CA (US)

(72) Inventors: Ryan Burgert, Port Jefferson, NY (US); Yuancheng Xu, Los Gatos, CA (US); Wenqi Xian, Los Angeles, CA (US); Oliver Pilarski, Gechingen (DE); Pascal Clausen, Villeneuve (CH); Mingming He, Los Angeles, CA (US); Li Ma, Los Angeles, CA (US); Yitong Deng, Los Gatos, CA (US); Lingxiao Li, Santa Clara, CA (US); Mohsen Mousavi, Vancouver (CA); Paul Debevec, Culver City, CA (US); Ning Yu, Los Angeles, CA (US)

(21) Appl. No.: 19/388,397

(22) Filed: Nov. 13, 2025

Related U.S. Application Data
(60) Provisional application No. 63/720,681, filed on Nov. 14, 2024.

(51) Int. Cl. G06T 5/70; G06N 3/0475; G06T 3/18; G06T 7/20

(52) U.S. Cl. CPC G06T 5/70; G06N 3/0475; G06T 3/18; G06T 7/20; G06T 2207/20084; G06T 2207/20182

(57) ABSTRACT

Methods for motion-controllable video diffusion include extracting optical flow fields from an input video and computing warped noise by iteratively warping noise between consecutive frames using the optical flow fields. The iteratively warping includes (i) re-Gaussianizing expanded pixel regions by sampling fresh Gaussian noise, and (ii) aggregating contracted pixel regions by merging noise particles and renormalizing variance to preserve spatial Gaussianity. An output video is generated by initializing a diffusion process with the warped noise and iteratively denoising to produce temporally coherent output frames. Various other methods, systems, and computer-readable media are also disclosed.

### CROSS REFERENCE TO RELATED APPLICATION

This application claims the benefit of U.S. Provisional Application No. 63/720,681, filed 14 Nov. 2024, the contents of which are incorporated, in their entirety, by this reference.

### BACKGROUND

Diffusion models are a category of generative models that produce data by progressively refining random noise into structured outputs, such as images or videos, through a denoising process. These models function by simulating a reverse diffusion mechanism, where data is gradually reconstructed from a noisy state to a clean state. The process starts with a random noise distribution, typically Gaussian noise, and applies a sequence of transformations guided by learned probability distributions to generate realistic outputs that correspond to the training data. In the context of video diffusion models, the challenge lies in maintaining temporal coherence across frames while preserving spatial fidelity, as videos involve complex spatiotemporal relationships. By utilizing advanced architectures, such as spatiotemporal tokenization and 3D autoencoders, video diffusion models aim to synthesize high-quality videos that demonstrate smooth transitions and consistent motion dynamics. These models have transformed generative modeling, enabling applications in video editing, animation, and content creation.

Over time, diffusion-based generative models have achieved high-quality video synthesis, yet these approaches typically sample independent noise for each frame and perform expensive per-frame denoising on large neural networks. In video diffusion scenarios, enforcing temporal coherence often entails introducing specialized attention mechanisms, additional conditioning networks, or optical flow estimators, each of which can substantially increase memory consumption and computational burden. Moreover, certain strategies depend on detailed motion parameters such as precise camera poses or finely tuned object trajectories. Such inputs can be difficult to obtain or estimate reliably in many real-world scenarios. Furthermore, extending diffusion architectures with extra modules or adapters for motion control can limit compatibility with full-attention models and degrade inference throughput. Accordingly, there remains a need for a unified approach to guide video diffusion with structured motion signals that maintains per-frame image fidelity and temporal consistency without imposing significant overhead or requiring extensive architectural modifications.

### SUMMARY

In some aspects, the techniques described herein relate to a computer-implemented method for motion-controllable video diffusion including: extracting optical flow fields from an input video including a plurality of frames; computing, for each frame in the plurality of frames, warped noise by iteratively warping a previous-frame noise to a current frame according to the extracted optical flow fields, wherein iteratively warping includes: re-Gaussianizing expanded pixel regions by sampling fresh Gaussian noise and aggregating contracted pixel regions by merging noise particles and renormalizing variance to preserve spatial Gaussianity; and generating an output video by initializing a diffusion process with the warped noise and iteratively denoising to produce temporally coherent output frames.

In some embodiments, the computer-implemented method further includes receiving, via a user interface, a user-provided motion control signal to generate the input video. In some embodiments, the user-provided motion control signal includes a bounding-box trajectory, a polygonal region translation, a depth-map warp, and/or an optical flow field derived from a reference video. In some examples, receiving the user-provided motion control signal includes receiving an indication of an area of an image and at least one of: a direction of movement of the area; a path of movement of the area; a rotation of the area; or a textual prompt with instructions to modify the image. In some aspects, receiving the user-provided motion control signal further includes receiving a degradation parameter for controlling smoothness of movement in the output video. In some embodiments, a degradation parameter is applied to the warped noise to form degraded warped noise based on a user-selectable degradation level; and a generative video diffusion model is fine-tuned using the degraded warped noise paired with the plurality of frames as training data. In some examples, extracting the optical flow fields includes applying a neural network-based optical flow estimation algorithm to each pair of temporally adjacent frames of the plurality of frames. In some examples, computing the warped noise includes mapping pixel positions of the previous-frame noise to pixel positions of a current-frame noise based on corresponding forward and backward optical flow vectors of the extracted optical flow fields. In some embodiments, aggregating the contracted pixel regions includes, for each current-frame pixel position in the contracted pixel regions: merging the noise particles by computing a weighted sum of the noise particles; and renormalizing the weighted sum of the noise particles to unit variance based on aggregate flow density. In some embodiments, for each frame in the plurality of frames, per-pixel flow density values indicating how much noise has been compressed into a respective pixel region are computed; and the previous-frame noise is scaled to the current frame in accordance with the flow density to preserve the spatial Gaussianity.

In some aspects, the techniques described herein relate to a system for motion-controllable video diffusion, the system including: a physical processor; and a memory storing instructions that, when executed by the physical processor, cause the system to: extract optical flow fields from an input video including a plurality of frames; compute, for each frame in the plurality of frames, warped noise by iteratively warping a previous-frame noise to a current frame according to the extracted optical flow fields, wherein iteratively warping includes: re-Gaussianizing expanded pixel regions by sampling fresh Gaussian noise and aggregating contracted pixel regions by merging noise particles and renormalizing variance to preserve spatial Gaussianity; and generate an output video by initializing a diffusion process with the warped noise and iteratively denoising to produce temporally coherent output frames.

In some examples, the instructions further cause the physical processor to receive, via a user interface, a user-provided motion control signal; and generate the input video based on the user-provided motion control signal. In some examples, receiving the user-provided motion control signal includes receiving, via the user interface, an indication of an area of an image; and receiving, via the user interface, at least one of: a direction of movement of the area, a path of movement of the area, a rotation of the area, or a textual prompt with instructions to modify the image. In some embodiments, the instructions further cause the physical processor to receive, via the user interface, a degradation parameter for controlling smoothness of movement in the output video. In some embodiments, the instructions further cause the physical processor to fine-tune a generative video diffusion model using the degradation parameter. In some examples, the instructions further cause the physical processor to extract the optical flow fields by applying a neural network-based optical flow estimation algorithm to each pair of temporally adjacent frames of the plurality of frames. In some embodiments, the instructions further cause the physical processor to map pixel positions of the previous-frame noise to pixel positions of a current-frame noise based on corresponding forward and backward optical flow vectors of the extracted optical flow fields.

In some aspects, the techniques described herein relate to a non-transitory computer-readable medium including one or more computer-executable instructions that, when executed by at least one processor of a computing device, cause the computing device to: extract optical flow fields from an input video including a plurality of frames; compute, for each frame in the plurality of frames, warped noise by iteratively warping a previous-frame noise to a current frame according to the extracted optical flow fields, wherein iteratively warping includes: re-Gaussianizing expanded pixel regions by sampling fresh Gaussian noise and aggregating contracted pixel regions by merging noise particles and renormalizing variance to preserve spatial Gaussianity; and generate an output video by initializing a diffusion process with the warped noise and iteratively denoising to produce temporally coherent output frames.

In some examples, the one or more computer-executable instructions further cause the computing device to receive, via a user interface, a user-provided motion control signal; and generate the input video based on the user-provided motion control signal. In some embodiments, the one or more computer-executable instructions further cause the computing device to receive, via a user interface, a degradation parameter for controlling smoothness of movement in the output video.

Features from any of the embodiments described herein can be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a flow diagram of an example method for motion-controllable video diffusion, according to at least one embodiment of the present disclosure.

FIG. 2 is a block diagram of a system for motion-controllable video diffusion, according to at least one embodiment of the present disclosure.

FIG. 3 is a block diagram of a system for motion-controllable video diffusion, according to at least one additional embodiment of the present disclosure.

FIG. 4 is a flow diagram illustrating a video diffusion process, according to at least one embodiment of the present disclosure.

FIGS. 5A and 5B are diagrams depicting a user interface for generating an output video in accordance with respective embodiments of the present disclosure.

FIGS. 6A and 6B are diagrams depicting a user interface for generating an output video in accordance with additional respective embodiments of the present disclosure.

FIG. 7 is a diagram illustrating how a degradation parameter affects output videos, according to at least one embodiment of the present disclosure.

FIG. 8 is a flow diagram illustrating a video diffusion process that starts with an input video, according to at least one embodiment of the present disclosure.

FIG. 9 is a diagram illustrating a video diffusion process that starts with an input video, according to at least one additional embodiment of the present disclosure.

FIG. 10 is a diagram illustrating a video diffusion process that starts with a user-provided motion control signal, according to at least one embodiment of the present disclosure.

FIG. 11 is a flow diagram showing a video diffusion process that starts with generation of a depth map, according to at least one embodiment of the present disclosure.

FIG. 12 illustrates a pixel map of two temporally adjacent pixel frames, according to at least one embodiment of the present disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The field of video diffusion models has seen significant advancements in generative modeling, enabling the transformation of random noise into structured outputs such as videos. However, existing approaches face notable challenges in maintaining temporal coherence across frames while preserving spatial fidelity. Conventional methods often rely on sampling independent noise for each frame, which leads to temporal inconsistencies such as flickering and unnatural motion dynamics. To address these issues, prior solutions have introduced specialized attention mechanisms, additional conditioning networks, or optical flow estimators. While these techniques improve temporal coherence, they impose substantial computational overhead, require extensive memory resources, and often necessitate complex hardware and/or software modifications. Furthermore, many existing methods depend on detailed motion parameters, such as precise camera poses or object trajectories, which are difficult to obtain or estimate reliably in real-world scenarios. These constraints limit the scalability, efficiency, and general applicability of current video diffusion models.

The present disclosure introduces an efficient approach to motion-controllable video diffusion by leveraging a real-time warped noise process. This concept addresses the aforementioned limitations by incorporating structured motion signals directly into the latent space of video diffusion models. Unlike prior methods, the proposed solution is agnostic to model architecture and training pipelines, requiring no additional layers, adapters, or significant modifications to the base model. The present disclosure includes a noise warping process that replaces random temporal Gaussian noise with temporally correlated warped noise derived from optical flow fields, while preserving spatial Gaussianity. This process operates iteratively, warping noise between consecutive frames rather than tracing back to the initial frame, thereby achieving linear time complexity and enabling real-time performance. Additionally, the disclosure introduces a degradation feature, which allows for the addition of Gaussian noise to the warped noise, facilitating smoother and more natural motion dynamics for synthetic and/or unnatural movements.

By fine-tuning video diffusion models with warped noise, the described approach harmonizes temporal coherence with per-frame pixel quality, ensuring high-quality video synthesis without compromising computational efficiency. The solution supports diverse motion control applications, including local object motion control, global camera movement control, and motion transfer, all while maintaining compatibility with modern full-attention architectures. Extensive experiments and user studies validate the advantages of the proposed method, demonstrating enhanced visual fidelity, motion controllability, and temporal consistency compared to existing techniques. This unified, scalable, and robust methodology represents a notable advancement in the domain of motion-controllable video diffusion models.

These concepts are applied to generating motion-controllable videos in the present disclosure. Accordingly, as will be described in greater detail below, the present disclosure describes systems and methods for real-time noise warping for motion-controllable video diffusion, which exhibit provable Gaussianity preservation, linear time complexity, and scalability. This approach can facilitate model-agnostic motion control, unified applications for diverse motion tasks, and/or fine-grained control over motion fidelity through a degradation parameter. The efficiency and simplicity of the disclosed concepts have led to rapid community adoption.

Warped noise represents an approach to structuring latent noise in video diffusion models, enabling motion control by correlating temporal noise distributions while maintaining spatial Gaussianity. Warped noise employs optical flow fields extracted from video frames to iteratively warp noise between consecutive frames, promoting temporal coherence without reverting to the starting frame, thereby achieving linear time complexity. In contrast to traditional methods that depend on intricate architectural modifications or additional computational layers, warped noise functions independently of the diffusion model architecture, requiring adjustments to model weights. Furthermore, the process can include integrating a degradation feature, which introduces Gaussian noise to the warped noise, supporting smoother and more natural motion dynamics for synthetic or unconventional movements. This scalable technique aligns temporal consistency with per-frame pixel fidelity, offering a reliable solution for various motion control applications, such as local object motion, global camera movement, and motion transfer.

Rather than warping each frame through a chain of operations from the initial frame, the disclosed methods iteratively warp noise between consecutive frames. This is achieved by carefully tracking the noise and the flow density along a forward and a backward flow at the pixel level, accounting for both expansion and contraction dynamics, supplemented with conditional noise sampling to preserve Gaussianity.

Gaussian noise refers to a type of statistical noise characterized by a probability density function that follows a normal distribution, also known as a Gaussian distribution. Gaussian noise can be defined by two parameters: a mean value, typically zero, and a standard deviation that determines the spread of the noise. Gaussian noise is commonly used in signal processing and generative modeling due to its mathematical properties, such as its simplicity and the central limit theorem, which makes it a natural choice for modeling random variations in data.

Spatial Gaussianity refers to the property of a noise distribution where the values across spatial dimensions exhibit a standard Gaussian distribution, such as exhibiting zero mean and unit variance, with no spatial autocorrelation between neighboring pixels. Spatial Gaussianity plays a role in diffusion-based generative modeling, as it ensures that the noise used during the denoising process is statistically consistent and unbiased, enabling the generation of high-quality outputs. Maintaining spatial Gaussianity can preserve and/or improve the integrity of the latent space and ensure that the generative model can accurately reconstruct structured outputs from the noise. Techniques of the present disclosure such as noise warping processes are employed to preserve spatial Gaussianity while introducing temporal correlations, ensuring that the noise remains Gaussian across frames while adhering to motion dynamics. This balance between spatial Gaussianity and temporal coherence contributes to achieving realistic and visually consistent results in video diffusion models.

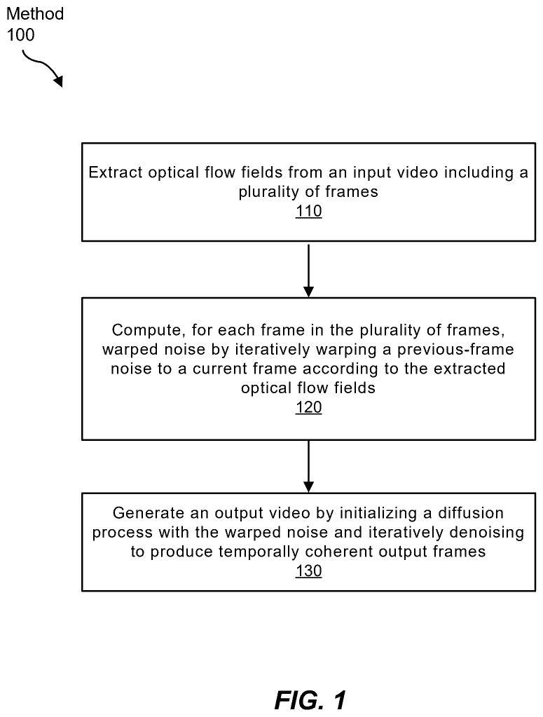

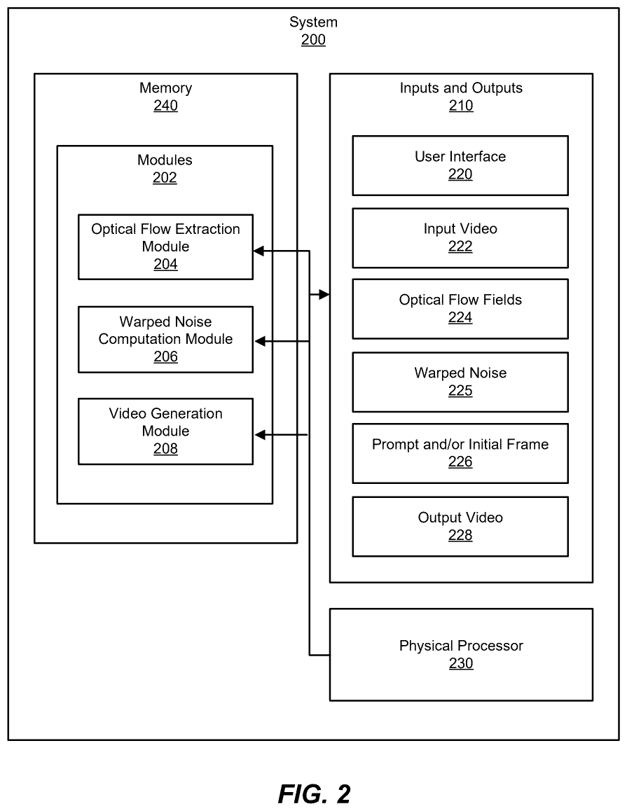

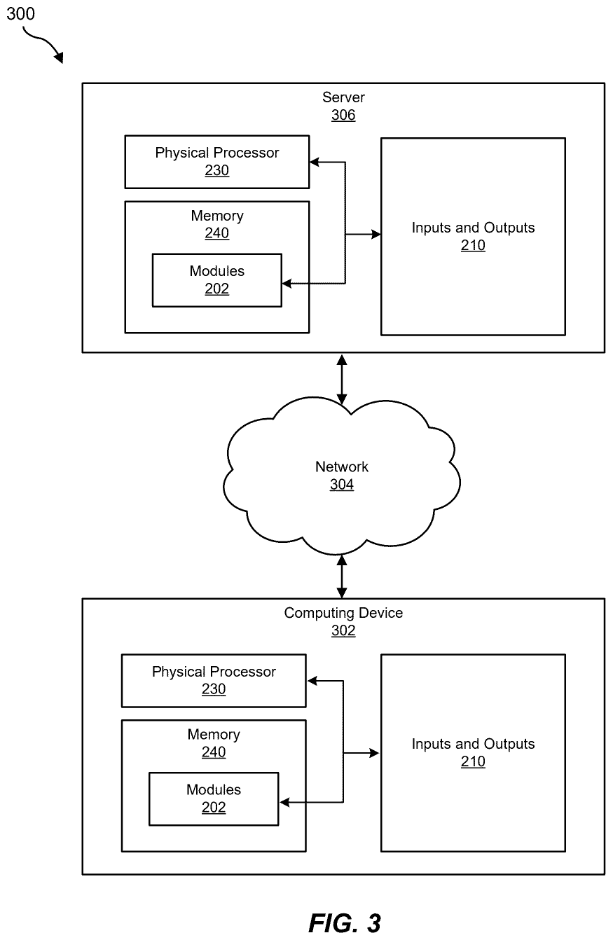

FIG. 1 is a flow diagram of an example computer-implemented method 100 for motion-controllable video diffusion. The steps shown in FIG. 1 are performed by any suitable computer-executable code and/or computing system, including systems 200, 300 respectively illustrated in FIG. 2 or FIG. 3. In one example, each of the steps of method 100 shown in FIG. 1 represent a process whose structure includes and/or is represented by multiple sub-steps, examples of which will be provided in greater detail below.

As illustrated in FIG. 2, system 200 includes a memory 240 that stores a plurality of modules 202, including an optical flow extraction module 204, a warped noise computation module 206, and a video generation module 208. System 200 further includes a physical processor 230 configured to execute instructions associated with these modules. Inputs and outputs 210 include a user interface 220, which allows users to provide an input video 222, a prompt and/or an initial frame 226, and receive output video 228. Optical flow extraction module 204 processes input video 222 to generate optical flow fields 224, which are then supplied to warped noise computation module 206. Warped noise computation module 206 utilizes the extracted optical flow fields 224 to generate temporally correlated, spatially Gaussian warped noise 225 for each frame, which is subsequently used by the video generation module 208, such as in connection with prompt and/or initial frame 226, to produce output video 228.

In some examples, system 200 is implemented as a standalone system capable of performing method 100. In additional examples, system 300 can incorporate system 200 and/or one or more components thereof, such as in a computing device 302 in communication with a network 304 and/or in a server 306 in communication with the network 304. Accordingly, in some examples, the discussion of system 200 of FIG. 2 and its components can be applicable to and/or implemented by system 300 of FIG. 3.

As illustrated in FIG. 1, at step 110 one or more of the systems 200, 300 described herein extracts optical flow fields from an input video including a plurality of frames. Systems 200, 300 described herein can perform step 110 in a variety of ways. For example, optical flow extraction module 204 of system 200 can extract optical flow fields 224 from an input video 222, such as by analyzing pairs of temporally adjacent frames within input video 222 and applying a neural network-based optical flow estimation process to each pair of temporally adjacent frames of the plurality of frames to determine pixel-wise motion vectors between each frame. In one example, optical flow extraction module 204 utilizes a recurrent all-pairs field transform (RAFT) or a similar deep learning architecture, which processes the intensity and spatial features of consecutive frames to estimate a direction and magnitude of movement for each pixel. The resulting optical flow fields 224 represent a dense mapping of motion across the video sequence, capturing both local object movements and global camera shifts. These optical flow fields 224 are then stored in memory 240 and provided to warped noise computation module 206 for subsequent processing and motion control in the video diffusion workflow.

In some embodiments, the term “optical flow field” can refer to a representation of the apparent motion of objects, surfaces, and/or edges within a visual scene, as observed from a sequence of images and/or video frames. An optical flow field is typically expressed as a dense mapping of motion vectors, where each vector indicates the direction and magnitude of movement for a specific pixel and/or pixel region between consecutive frames.

In some examples, input video 222 can be generated in connection with receiving a user-provided motion control signal via user interface 220. A user specifies, via user interface 220, motion control signals in various forms, such as drawing a bounding-box trajectory, selecting a polygonal region for translation, providing a depth map, and/or uploading or selecting a reference video from which motion is to be transferred. For example, the user can select an area of an initial image and drag the area across the initial image to provide system 200 with a desired movement. The dragging of the area can include translation and/or rotation of area.

Upon receiving any of these inputs from the user, system 200 generates input video 222 that reflects the desired motion pattern or transformation based on the user's motion control signal. This input video 222 is then processed by optical flow extraction module 204, which analyzes the sequence of frames to compute optical flow field 224. The resulting optical flow field 224 encodes the pixel-wise motion vectors corresponding to the user's intended movement, serving as a structured motion signal for subsequent computation of warped noise 225 and generation of output video 228. This approach allows users to directly influence the motion dynamics of output video 228, supporting a wide range of creative and practical applications.

For example, the user, via the user interface, provides a motion control signal by selecting an area of the initial image and indicating one or more of: an intended direction of movement of the area, an intended path of movement of the area, an intended rotation of the area, and/or a textual prompt with instructions to modify the image, such as to direct system 200 to move the selected area, zoom in, zoom out, move the camera in a particular way, alter an image within the selected area, etc.

In some embodiments, system 200 receiving the motion control signal can include receiving a degradation parameter for controlling smoothness of movement of output video 228. The degradation parameter can be a user-selectable value between zero and one that modulates the smoothness and/or naturalness of motion dynamics in the disclosed video diffusion model by introducing additional Gaussian noise to warped noise 225. This degradation parameter allows for fine-grained adjustment of motion fidelity during the video generation process. Specifically, the degradation parameter blends clean warped noise with uncorrelated Gaussian noise, where the level of degradation is determined by the value of the degradation parameter.

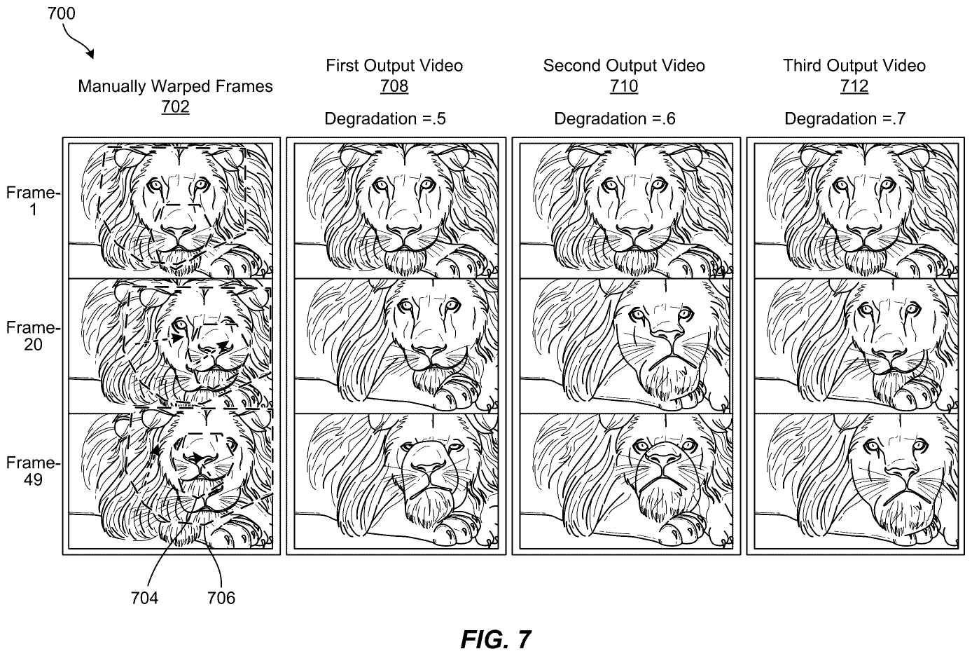

As the degradation parameter approaches zero, warped noise 225 remains highly correlated with the input motion, resulting in precise adherence to the intended motion patterns. Conversely, as the degradation parameter approaches one, warped noise 225 becomes increasingly uncorrelated, allowing the video diffusion model to rely more heavily on pre-existing priors, thereby producing smoother and more natural motion dynamics, although not necessarily strictly adhering to the input motion control signal. This flexibility enables users to tailor the motion control to suit various applications, such as synthetic object movements requiring higher degradation for realism or motion transfer tasks demanding lower degradation for strict motion fidelity. An example of applying a degradation parameter is described below with reference to FIG. 7.

Referring again to method 100 of FIG. 1, at step 120, one or more of systems 200, 300 computes, for each frame in the plurality of frames of the input video, warped noise by iteratively warping a previous-frame noise to a current frame according to the extracted optical flow fields. The systems 200, 300 described herein can perform step 120 in a variety of ways. For example, warped noise computation module 206 computes warped noise 225 for each frame by utilizing the extracted optical flow fields 224 to map pixel positions from the previous-frame noise to the current frame noise.

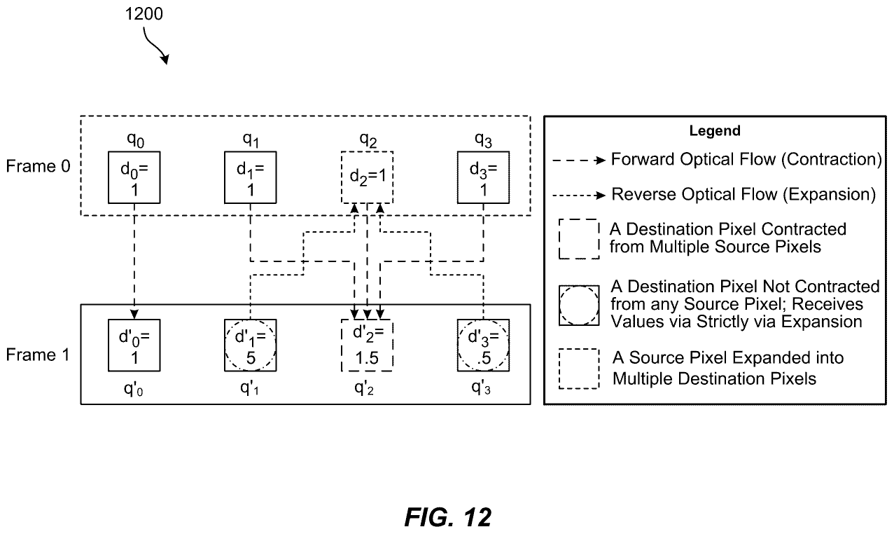

This process of computing warped noise 225 involves tracking both expansion and contraction dynamics at a pixel level, where expanded regions (e.g., regions where the camera appears to zoom in or get closer to an object) are re-Gaussianized by sampling fresh Gaussian noise, and contracted regions (e.g., regions where the camera appears to zoom out or become more distant from an object) are aggregated by merging noise particles and renormalizing their variance to preserve spatial Gaussianity. An example process for tracking and controlling expansion and contraction dynamics at the pixel level is described below with reference to FIG. 12.

In some examples, re-Gaussianizing the expanded regions by sampling fresh Gaussian noise includes generating new noise values for each pixel position within the expanded regions by independently sampling from a standard Gaussian distribution. This process is triggered when the optical flow mapping indicates that certain pixels in the current frame do not have corresponding source pixels from the previous frame, typically due to expansion effects such as zooming in or a depicted object movement toward the camera. By warped noise computation module 206 replacing these pixel values with freshly sampled Gaussian noise, system 200 ensures that the statistical properties (e.g., zero mean and unit variance) of warped noise 225 are maintained across the spatial dimensions of the frame. This re-Gaussianization step preserves spatial Gaussianity in expanded regions and prevents the accumulation of duplicate or correlated noise values, thereby supporting the generation of high-quality, temporally coherent video outputs.

In some examples, aggregating the contracted region by merging noise particles and renormalizing their variance to preserve spatial Gaussianity includes identifying each current-frame pixel position within the contracted regions that receives contributions from multiple noise particles mapped from the previous frame. For each such pixel, warped noise computation module 206 computes a weighted sum of the incoming noise particles, where the weights are determined by the flow density and/or the number of particles converging at that location. After calculating the weighted sum, the system renormalizes the resulting value to unit variance, ensuring that the aggregated noise maintains the statistical properties of a standard Gaussian distribution. This renormalization process preserves spatial Gaussianity throughout the contraction dynamics, preventing distortion or bias in the noise distribution. By maintaining these statistical properties, system 200 supports the generation of temporally consistent and visually coherent video frames during the diffusion process.

In some embodiments, aggregating the contracted pixel regions includes identifying each current-frame pixel position within the contracted regions by merging the noise particles that have been mapped to that position from the previous frame. This merging is accomplished by computing a weighted sum of the noise particles, where the weights are determined according to the flow density or the number of contributing particles. After the weighted sum is calculated, the system renormalizes the resulting value to unit variance, ensuring that the statistical properties of spatial Gaussianity are preserved. The renormalization is based on the aggregate flow density, which reflects the total contribution of noise particles to the contracted pixel region. This approach maintains the integrity of the noise distribution throughout the warping process, supporting temporally coherent and visually consistent video generation.

In some examples, warped noise computation module 206 computes warped noise 225 by constructing a bipartite graph to represent correspondence between pixels in consecutive frames, ensuring that each pixel in the current frame receives an appropriate noise value based on corresponding motion vectors. Additionally, the computation maintains a per-pixel flow density map to accurately scale and combine noise contributions, further supporting the preservation of statistical properties. By iteratively applying this warping process across all frames, system 200 generates a sequence of temporally correlated, spatially Gaussian noise tensors (e.g., warped noise 225) that serve as motion-conditioned inputs for a subsequent video diffusion process to produce output video 228.

In some examples, warped noise computation module 206 can compute warped noise 225 by mapping pixel positions of the previous-frame noise to pixel positions of a current-frame noise based on corresponding forward and backward optical flow vectors of the extracted optical flow fields.

Referring again to FIG. 1, at step 130, one or more of the systems 200, 300 described herein generates an output video by initializing a diffusion process with the warped noise and iteratively denoising to produce temporally coherent output frames. Step 130 can be performed by systems 200, 300 in a variety of ways. For example, video generation module 208 of system 200 can generate output video 228 by initializing the video diffusion process using warped noise 225 as the starting point for each frame in the sequence. In some examples, a prompt and/or initial frame 226 is received from the user via user interface 220 and used by video generation module 208 in combination with warped noise 225 to generate output video 228. For example, video generation module 208 applies an iterative denoising process to warped noise 225, which progressively refines the noisy input through a series of learned transformations, ultimately reconstructing clean and temporally coherent output frames of output video 228. Throughout this process, video generation module 208 leverages the temporal correlations embedded in warped noise 225 to guide the generative model, ensuring that motion dynamics specified by the user and/or derived from input video 222 are preserved. The result is an output video 228 that exhibits both high per-frame image fidelity and smooth, consistent motion across frames, effectively translating the structured motion signals encoded in warped noise 225 into realistic and/or smooth video content.

In some examples, method 100 also includes computing, for each frame in the plurality of frames, per-pixel flow density values indicating how much noise has been compressed into a respective pixel region, and scaling the previous-frame noise to the current frame in accordance with the flow density to preserve the spatial Gaussianity. Calculating flow density values can be performed by tracking the movement and aggregation of noise particles as they are mapped from the previous frame to the current frame according to optical flow fields 224. For each pixel in the current frame, system 200 determines the number of noise contributions received from the previous frame, which is represented as the flow density value for that pixel. These flow density values are then used to scale and combine the incoming noise particles, ensuring that the resulting noise maintains unit variance and adheres to the statistical properties of a standard Gaussian distribution to preserve spatial Gaussianity throughout the warping process.

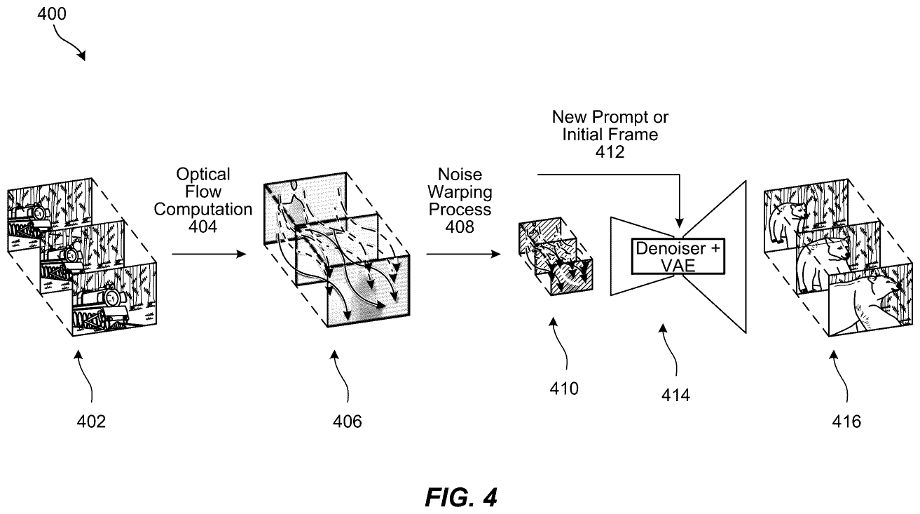

FIG. 4 is a flow diagram illustrating a video diffusion process 400, according to at least one embodiment of the present disclosure.

In the embodiments described herein, video diffusion process 400 is carried out in a variety of ways to generate motion-controllable video outputs. In some embodiments, the systems described herein integrate multiple components including input video 402, optical flow computation 404, optical flow fields 406, a noise warping process 408, warped noise 410, a new prompt and/or initial frame 412, and a diffusion model 414 that receives warped noise 410 and optionally new prompt and/or initial frame 412 to generate an output video 416 with temporally coherent and spatially consistent results. Each component can contribute to guiding the workflow from input video 402 to output video 416.

In some embodiments, input video 402 can serve as a foundational data source for video diffusion process 400. Input video 402 includes a sequence of frames that capture motion dynamics and spatial features of a scene. Input video 402 can be provided by a user (e.g., via a user interface) and/or generated based on a user-defined motion control signal (e.g., a bounding-box trajectory, a polygonal region translation, a depth map, a reference video, etc.). Input video 402 is analyzed to extract motion information, which can guide downstream components of video diffusion process 400. Input video 402 can include diverse content ranging from natural scenes to synthetic animations or user-edited sequences depending on the intended application. In the example of FIG. 4, input video 402 depicts a train traveling through a forest from left to right.

In some embodiments, optical flow computation 404 derives optical flow fields 406 from input video 402 by analyzing pairs of temporally adjacent frames, such as by using a neural-network based optical flow estimation process, such as RAFT. Optical flow computation 404 provides pixel-wise motion vectors that describe the direction and magnitude of movement for each pixel of input video 402 between consecutive frames. The resulting motion vectors can be used to generate optical flow fields 406, which are employed in noise warping process 408.

The systems described herein can generate optical flow fields 406 in a variety of ways. In some examples, optical flow fields 406 can include dense mappings of motion vectors that capture both local object movements and global camera shifts across the video sequence. In the example of FIG. 4, optical flow fields 406 are stored in memory and subsequently serve as inputs to noise warping process 408. By encoding the motion information of input video 402, optical flow fields 406 can enable spatially and temporally correlated noise generation in later stages.

In some embodiments, noise warping process 408 utilizes optical flow fields 406 to produce temporally correlated, spatially Gaussian noise patterns. The disclosed noise warping process 408 can iteratively warp noise between consecutive frames based on optical flow fields 406 while preserving spatial Gaussianity. In this example, noise warping process 408 handles expansion and contraction dynamics at the pixel level by re-Gaussianizing expanded regions and aggregating contracted regions to maintain statistical consistency. Noise warping process 408 produces warped noise 410 to serve as a motion-conditioned input for diffusion model 414.

In some embodiments, warped noise 410 includes a sequence of temporally correlated noise tensors structured to reflect motion dynamics encoded in optical flow fields 406. In the example of FIG. 4, warped noise 410 initializes the video diffusion process 400, providing a motion-conditioned starting point for the generative model. Warped noise 410 ensures that generated frames of output video 416 exhibit smooth and consistent motion dynamics aligned with motion patterns of input video 402 and/or user-defined motion control signals.

In some embodiments, new prompt and/or initial frame 412 can be provided as an optional input to specify desired content and/or context for output video 416. The prompt can include a textual description such as “a bear walking,” and/or an initial frame image (e.g., an image of a bear) can serve as a visual reference for video diffusion generation. In some examples, new prompt and/or initial frame 412 is combined with warped noise 410 to guide diffusion model 414 in producing output video 416. New prompt and/or initial frame 412 can enable users to customize both content and motion dynamics, offering a wide range of applications.

The systems described herein employ diffusion model 414 as a primary generative component of video diffusion process 400. In some embodiments, diffusion model 414 is initialized with warped noise 410 and optionally guided by new prompt and/or initial frame 412 to produce output video 416. In the example of FIG. 4, diffusion model 414 iteratively denoises warped noise 410 to reconstruct clean and temporally coherent frames. Diffusion model 414 is fine-tuned with warped noise 410 during training to learn motion-conditioned generative patterns. Additionally, diffusion model 414 can be compatible with modern full-attention architectures and can be implemented using a video diffusion model. In some examples, diffusion model 414 includes a variational autoencoder (VAE) that encodes video frames into a lower-dimensional latent space and subsequently decodes the denoised latent representations back into high-fidelity video frames. The VAE facilitates efficient learning of spatiotemporal features and enables diffusion model 414 to reconstruct realistic video content from the motion-conditioned warped noise 410. By leveraging the VAE architecture, diffusion model 414 can maintain both temporal coherence and spatial detail throughout the video generation process.

In some embodiments, output video 416 is the final result of video diffusion process 400. Output video 416 can include a sequence of temporally coherent and spatially consistent frames that adhere to motion dynamics encoded in warped noise 410 and optionally content specified by new prompt and/or initial frame 412. Output video 416 demonstrates high per-frame image fidelity and smooth motion transitions, effectively translating structured motion signals into realistic and visually appealing video content. Output video 416 can be used for various applications including local object motion control, global camera movement control, and motion transfer, making the disclosed system a versatile solution for motion-controllable video generation.

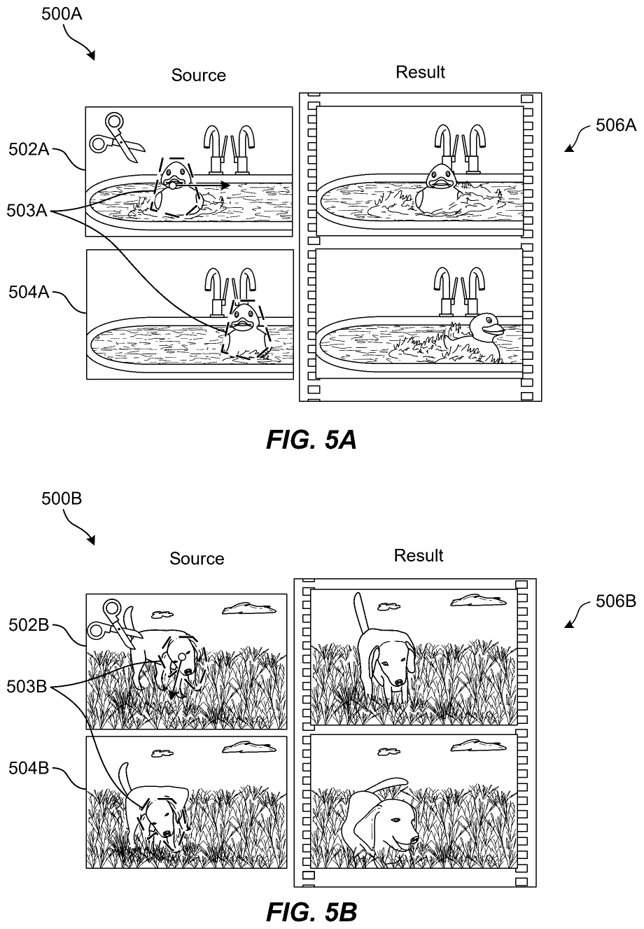

FIGS. 5A and 5B are diagrams depicting respective user interfaces 500A, 500B for generating output videos 506A, 506B in accordance with respective embodiments of the present disclosure.

In some embodiments, user interface 500A can include a graphical interface that facilitates user interaction with the motion-controllable video diffusion system. In these embodiments, the user interface 500A includes tools for selecting, modifying, and controlling specific areas of an image and/or video frame. For example, in FIG. 5A, the user interface 500A can include a visual representation of an initial image 502A. The user can manipulate initial image 502A to result in a modified image 504A. User interface 500A can present tools for defining area 503A of interest. User interface 500A allows users to interact with the system by selecting and manipulating area 503A to define motion trajectories and/or transformations. By interacting with user interface 500A, users can perform video editing tasks with little or no technical expertise.

In some embodiments, initial image 502A represents an original, unaltered frame of a video or a standalone image that serves as a starting point for a video editing or generation process. In the example of FIG. 5A, initial image 502A depicts a static scene of a duck in a bathtub. Initial image 502A can be manipulated by the user to generate modified image 504A. Initial image 502A and/or modified image 504A serve as an input to systems disclosed herein to generate warped noise and ultimately an output video 506A. In these embodiments, initial image 502A is displayed within the user interface 500A, allowing users to define and select area 503A for subsequent modification.

In some embodiments, modified image 504A can be the result of user-defined modifications applied to initial image 502A. In the example of FIG. 5A, modified image 504A shows the duck in the bathtub with a user-defined motion trajectory applied to the duck's position, effectively moving the duck to the right compared to initial image 502A. The modifications can be made using the tools provided in user interface 500A, such as by selection and manipulation of area 503A. Modified image 504A serves as an intermediate step in the video editing and/or generation process, providing a visual preview of the changes before generating the output video 506A.

In some embodiments, area 503A is a user-defined region within initial image 502A that is selected for modification. In the example of FIG. 5A, area 503A is represented by a bounding box or polygonal region around the duck in the bathtub. This area can be defined using tools available in user interface 500A, such as a cut and drag tool. In these embodiments, area 503A specifies the portion of the image that will be manipulated, for example by applying motion trajectories, transformations, and/or other effects. The system can use area 503A and user-provided manipulations of area 503A to generate optical flow fields and warped noise, which guides the motion-controllable video diffusion process.

In some embodiments, output video 506A can be the final result of the motion-controllable video diffusion process. In the example of FIG. 5A, output video 506A shows the duck in the bathtub moving along the user-specified trajectory, with realistic motion dynamics and temporal coherence. The generation of output video 506A can involve initializing the diffusion model with warped noise derived from the optical flow fields and the user-defined modifications applied to initial image 502A. Output video 506A demonstrates the system's ability to translate user-defined motion signals into high-quality, temporally consistent video content.

FIG. 5B illustrates another user interface 500B that is similar to user interface 500A of FIG. 5A in at least some respects. For example, user interface 500B can include tools provided for a user to manipulate an initial image 502B to create a modified image 504B. In the example of FIG. 5B, the user has selected an area 503B of initial image 502B including a dog's head and has moved area 503B downward and to the left. Systems of the present disclosure extract optical flow fields from this user-provided motion control signal to generate warped noise. This warped noise is provided as an input to a video diffusion model. The video diffusion model generates an output vide 506B, showing a dog that moves naturally along the path indicated by the user.

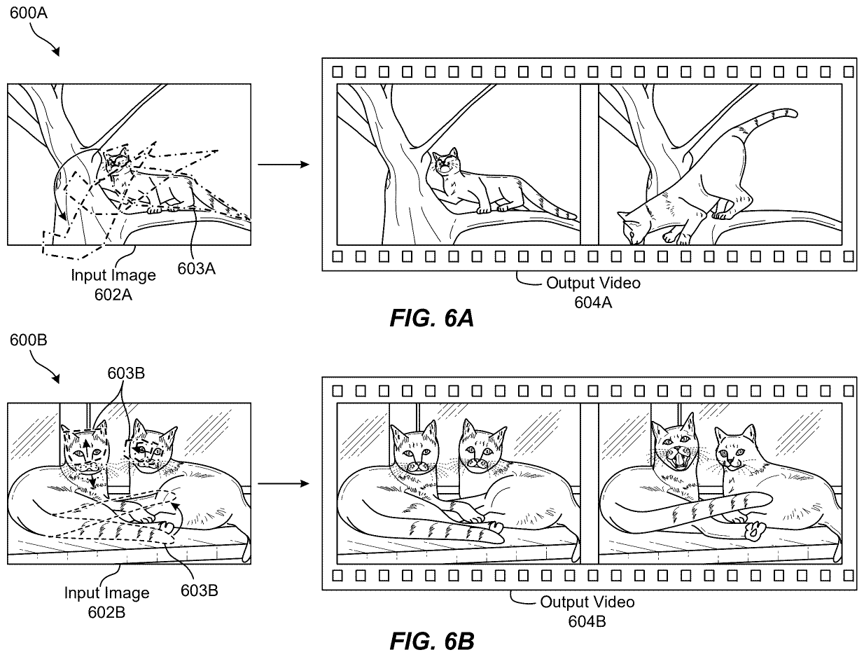

FIGS. 6A and 6B are diagrams depicting user interfaces 600A, 600B for generating respective output videos 604A, 604B in accordance with additional embodiments of the present disclosure.

In some embodiments, user interface 600A serves as a primary interaction medium for users to provide input and control the motion controllable video diffusion system. User interface 600A can include one or more tools for selecting and manipulating specific areas of an input image 602A, such as drawing bounding boxes, defining motion trajectories, and/or applying transformations including translation, rotation, and scaling. In the example of FIG. 6A, user interface 600A allows users to define motion control signals and specify desired modifications to the input image 602A. Additionally, user interface 600A can provide real time feedback, enabling users to preview effects of modifications before generating a final output video 604A. The system processes these user-defined inputs to generate motion control signals that guide the video diffusion process, which can facilitate intuitive and user-friendly interaction.

In some embodiments, input image 602A represents an image provided or selected by the user through user interface 600A. For example, in FIG. 6A, input image 602A can be a static image of a cat sitting on a tree branch. In the example of FIG. 6A, the user selects an area 603A including the cat and translates and rotates area 603A along the tree branch and down the tree trunk. In additional embodiments, the user can manipulate area 603A by applying transformations such as translation, rotation, or scaling, or by defining a motion trajectory. The system analyzes input image 602A, user-selected area 603A, and these user-provided motion control signals to extract relevant features such as spatial details and motion dynamics to generate optical flow fields. These optical flow fields guide noise warping and subsequent video diffusion processes to generate output video 604A.

In some embodiments, output video 604A is produced by initializing the diffusion model with warped noise derived from input image 602A and the user defined motion control signals associated with area 603A. In the example of FIG. 6A, output video 604A depicts a sequence of frames showing the cat moving along the user specified trajectory, transitioning from sitting on the tree branch to climbing down. Output video 604A demonstrates the system's ability to maintain high per-frame image fidelity and temporal coherence, effectively translating the structured motion signals into realistic and visually consistent video content. Output video 604A is displayed to the user via user interface 600A, providing a visual representation of the applied motion control.

FIG. 6B illustrates another user interface 600B that is similar to user interface 600A of FIG. 6A in at least some respects. For example, user interface 600B can include tools provided for a user to manipulate input image 602B. In the example of FIG. 6B, a user has selected multiple distinct areas 603B and provided corresponding distinct motion-control signals for each of the areas 603B. In this example, one of the areas 603B is a mouth region of a first cat, another is a head of the first cat, another area 603B is a tail of the first cat, and a final area 603B is a face of a second cat. Based on the respective trajectories provided by the user for these areas 603B, optical flow fields and subsequent warped noise are generated. The warped noise is input to a video diffusion model along with input image 602B, and an output video 604B is generated by the diffusion model to include the first cat moving its head, opening its mouth, and moving its tail while the second cat shifts its head. All of these movements track the user's motion-control signals (e.g., in the form of areas 603B and their respective trajectories) with temporal and spatial coherence.

FIG. 7 is a diagram 700 illustrating how a degradation parameter affects output videos 708, 710, 712, according to at least one embodiment of the present disclosure.

Diagram 700 illustrates a comparison of manually warped frames 702 and resulting output videos 708, 710, and 712 generated using different degradation parameter values. Diagram 700 is structured to show the progression of motion across three distinct frames, Frame 1, Frame 20, and Frame 49, for each of the first output video 708, second output video 710, and third output video 712, to provide a comparison. Manually warped frames 702 serve as input motion control signals, while the output videos 708, 710, and 712 demonstrate the effect of varying degradation parameters on adherence to these signals and on the smoothness of the generated motion.

In the example shown in FIG. 7, manually warped frames 702 represent user-defined motion control signals applied to specific areas of a lion's image. In this example, the frames depict the movement of two distinct areas, namely the snout (first area 704) and the head (second area 706) of the lion, across a timeline defined by Frame 1 through Frame 49. In the example of FIG. 7, the manually warped frames 702 serve as a baseline for evaluating both the fidelity to the user signals and the smoothness of the generated output videos 708, 710, and 712. Thus, the user-defined motion trajectories of the snout and head can guide the video diffusion process.

In the embodiment of FIG. 7, first area 704 corresponds to the snout of the lion. Between Frame 1 and Frame 20, the snout is moved upward and to the right following a trajectory defined by the user. Between Frame 20 and Frame 49, the snout is moved upward and to the left along a new trajectory. The motion of the snout is distinct from the motion of the head (second area 706) as the snout follows a different angle and direction. Additionally, movement of the snout can be encoded into warped noise, which serves as input to the video diffusion process.

In the embodiment of FIG. 7, second area 706 corresponds to the head of the lion. Between Frame 1 and Frame 20, the head is moved upward and to the right at an angle different from that of the snout. Between Frame 20 and Frame 49, the head is moved upward and to the right again, but along a new angle distinct from the prior trajectory. In these embodiments, the motion of the head is encoded separately into the warped noise to ensure that the video diffusion process generates temporally coherent and spatially consistent motion dynamics for the lion's head as defined by the user.

First output video 708 is generated using a degradation parameter set to 0.5. In this embodiment, this results in a relatively strong adherence to the user-defined motion control signals encoded in the manually warped frames 702. In the example of FIG. 7, the lion's snout and head relatively closely follow the specified trajectories, maintaining high fidelity to the input signals. However, the motion dynamics can appear less smooth and/or less natural compared to higher degradation parameter values, as the system prioritizes strict adherence to the user-defined signals when the low degradation parameter value is applied.

Second output video 710 is generated using a degradation parameter set to 0.6. In this embodiment, this results in medium adherence to the user-defined motion control signals. As a result, the lion's snout and head follow the specified trajectories with moderate fidelity, while the motion dynamics can exhibit smoother transitions compared to those in first output video 708. Additionally, the degradation parameter causes the introduction of more Gaussian noise to the warped noise compared to the first output video 708, thereby balancing adherence to the input signals with smoother and more natural motion dynamics.

Third output video 712 is generated using a degradation parameter set to 0.7. In this embodiment, this results in relatively low adherence to the user-defined motion control signals but yields smoother and more natural motion dynamics compared to both the first output video 708 and second output video 710. The higher degradation parameter value used to generate third output video 712 introduces increased Gaussian noise to the corresponding warped noise, allowing the video diffusion model to rely more heavily on pre-existing priors. Thus, for relatively higher degradation parameter values, motion dynamics are less precise relative to the user-provided motion control signal, but visually more fluid and realistic, particularly for synthetic and/or unnatural movements provided by the user.

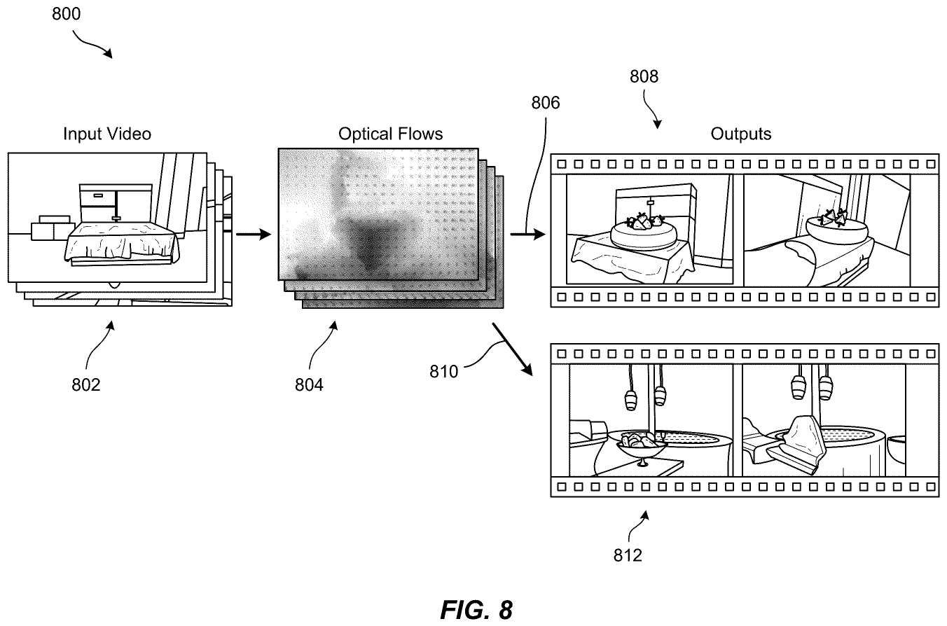

FIG. 8 is a flow diagram illustrating a video diffusion process 800 that starts with an input video 802, according to at least one embodiment of the present disclosure.

In some embodiments, the video diffusion process 800 shown in FIG. 8 represents an overall workflow for generating motion-controllable video outputs based on structured inputs, including videos, images, and/or text prompts. Video diffusion process 800 receives an input video 802 and extracts optical flows 804 and corresponding warped noise to improve temporal coherence and spatial fidelity in generated output videos 808, 812.

In some embodiments, input video 802 serves as a foundational data source for video diffusion process 800. In the context of FIG. 8, input video 802 shows a table viewed from various angles, capturing spatial and temporal dynamics of the scene. Input video 802 provides motion information used for generating optical flows 804, which can encode the pixel-wise movement between consecutive frames. This motion data is then used to guide subsequent noise-warping and video-generation steps. In these embodiments, input video 802 can be provided by a user or selected from a pre-existing dataset, and serves as the reference for maintaining consistent camera angles and motion patterns in output videos 808, 812.

In some embodiments, optical flows 804 are derived from input video 802 and represent a dense mapping of motion vectors between consecutive frames. In the example of FIG. 8, optical flows 804 are computed using a neural network-based optical flow estimation process such as RAFT, which analyzes the intensity and spatial features of adjacent frames in input video 802. Optical flows 804 describe both local object dynamics and global camera shifts. Optical flows 804 are then used to generate warped noise, helping to ensure that the motion dynamics of input video 802 are preserved in output videos 808, 812. In these embodiments, optical flows 804 are stored in memory and serve as a structured motion signal for guiding video diffusion process 800.

FIG. 8 demonstrates that, once optical flows 804 and corresponding warped noise is generated, such as based on a user selection and/or user-provided motion control signal, various video generation tasks can be completed without re-calculating optical flows 804 and/or warped noise. For example, input image 806 is a user-provided and/or user-selected image that gives additional visual context for video diffusion process 800. In the example of FIG. 8, input image 806 depicts a cake, which is used as the primary subject for generating output video 808. Input image 806 is combined with optical flows 804 and corresponding warped noise to ensure that the generated output video 808 incorporates the motion dynamics of input video 802 while maintaining the visual fidelity of input image 806. As a result, the system synthesizes output video 808 in which the subject (e.g., the cake) is integrated into the scene depicted in input video 802, adhering to the same camera angles and motion patterns.

In another embodiment, text prompt 810 provides semantic guidance for the video diffusion process 800. In the example of FIG. 8, text prompt 810 can specify “an outdoor hot tub,” which serves as a basis for generating output video 812. Text prompt 810 can be processed by the video diffusion model to influence the content and context of the generated video, helping to ensure alignment with the user-defined description. When combined with optical flows 804 and corresponding warped noise, text prompt 810 causes the system to generate output video 812 that follows the motion dynamics of input video 802 while including the specified semantic elements, such as the hot tub in place of the table of input video 802.

In some embodiments, output video 808 is generated by the video diffusion model using input video 802, optical flows 804 and corresponding warped noise, and input image 806. In the example of FIG. 8, output video 808 shows a cake on the table, viewed from the same consistent angles as those in input video 802. Video diffusion process 800 ensures that the motion dynamics of input video 802 are preserved, resulting in a temporally coherent and spatially consistent video. Output video 808 demonstrates the system's ability to integrate a new subject such as the cake into the scene while maintaining the original camera movements and perspectives.

In some embodiments, output video 812 is generated by the video diffusion model using input video 802, optical flows 804 and corresponding warped noise, and text prompt 810. In the example of FIG. 8, output video 812 shows a hot tub viewed from the same angles as the table in input video 802. Text prompt 810 guides the semantic content of the video, helping to ensure that the generated video aligns with the user-defined description. The video diffusion process 800 harmonizes the motion dynamics of input video 802 with the semantic elements (e.g., the hot tub) specified in text prompt 810, resulting in a realistic and visually consistent output video 812 that follows the camera movement of input video 802.

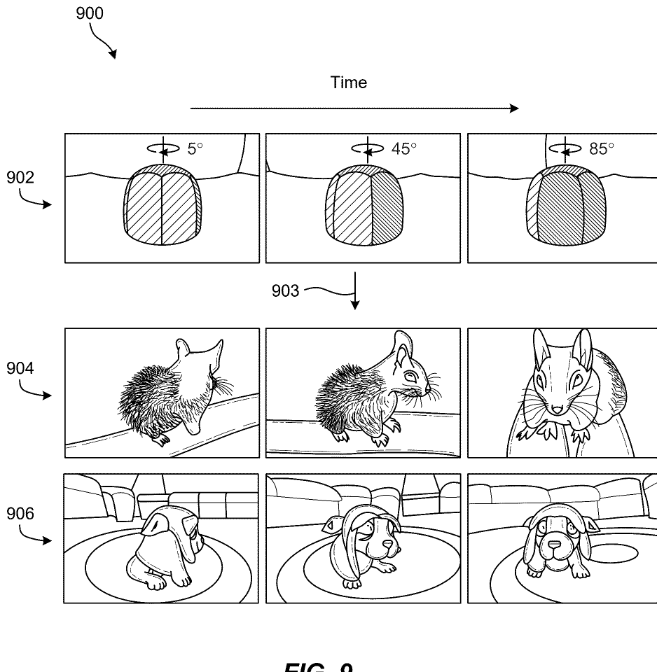

FIG. 9 is a diagram 900 illustrating a video diffusion process that starts with an input video 902, according to at least one additional embodiment of the present disclosure.

In this example, input video 902 is a generic object that is viewed from a camera rotating around the generic object. Optical flows and corresponding warped noise are generated based on this input video 902. A text prompt 903 provided to a video diffusion model can result in a first output video 904 or a second output video 906, depending on contents of the text prompt 903. For example, when text prompt 903 is “a squirrel sitting on a log,” first output video 904 shows a squirrel from the same camera views as input video 902. In another example, when text prompt is “a puppy on a circular rug,” output video 906 shows a puppy on a circular rug shown from the same camera views as input video 902. Accordingly, optical flows and corresponding warped noise can be extracted from a single input video 902, which can then be used to generate multiple different output videos 904, 906, such as depending on text prompt 903 and/or another user input. This reusability of generated optical flows and warped noise provides a computationally efficient and low-cost way of generating any number of output videos.

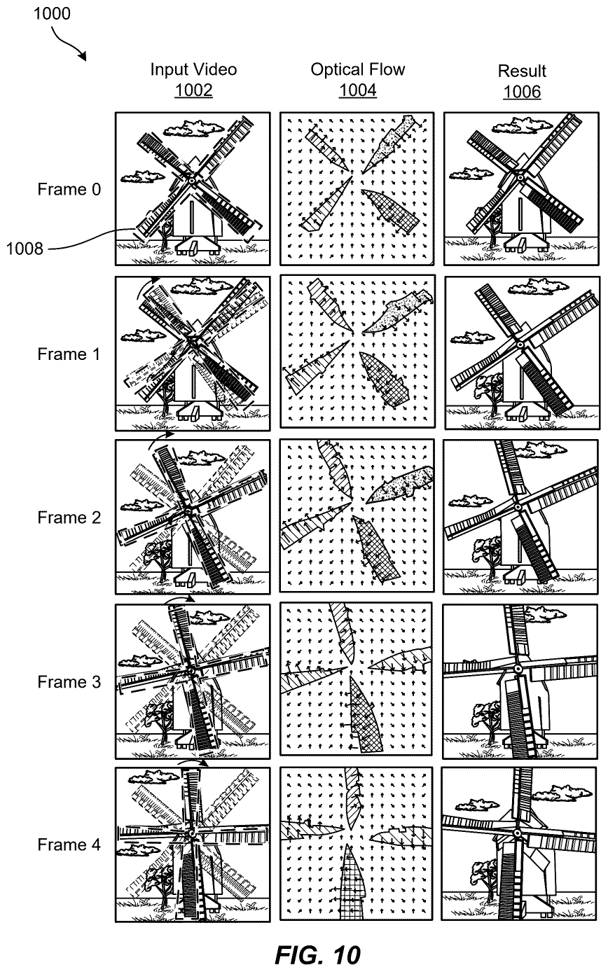

FIG. 10 is a diagram illustrating a video diffusion process that starts with a user-provided motion control signal, according to at least one embodiment of the present disclosure.

Diagram 1000 illustrates a sequential process of motion-controllable video diffusion applied to a windmill scene. Diagram 1000 is divided into three columns: an input video 1002, an optical flow 1004, and a result 1006. Each column is further subdivided into frames, labeled Frame 0 through Frame 4, representing a temporal progression of the video. In the example of FIG. 10, diagram 1000 visually demonstrates how the disclosed system processes an input video 1002 to generate a result 1006 in the form of a motion-controlled output video, showcasing transformation of the windmill's motion through the application of optical flow 1004 and warped noise.

In this example, input video 1002 represents the original image manipulated by a user who selected area 1008 and rotated this area 1008 sequentially from frame 0 to frame 4. In the example of FIG. 10, the input video 1002 includes a windmill rotating clockwise across the multiple frames 0-4. Input video 1002 serves as a foundational data source for the motion-controllable video diffusion process. Each frame in the input video 1002 captures desired spatial and temporal dynamics of the windmill's rotation, which are analyzed to extract motion information. Input video 1002 is processed by the optical flow extraction module 204 to compute optical flow 1004, which encodes the pixel-wise motion vectors between consecutive frames. This motion data plays a role in guiding the subsequent noise warping and video generation steps.

In some embodiments, optical flow 1004 represents a dense mapping of motion vectors derived from input video 1002. In the example of FIG. 10, each frame in optical flow 1004 corresponds to a specific frame in input video 1002 and captures a direction and magnitude of movement for each pixel. Optical flow 1004 illustrates the rotational motion of the windmill blades, with arrows indicating pixel-wise movement between consecutive frames. Optical flow 1004 is computed using a neural network-based optical flow estimation process such as RAFT, which analyzes the intensity and spatial features of adjacent frames. This data is then used by a warped noise computation module to generate temporally correlated, spatially Gaussian warped noise, ensuring that the motion dynamics of input video 1002 are preserved in result 1006.

In some embodiments, result 1006 represents an output video generated by the motion-controllable video diffusion system. In the example of FIG. 10, each frame in result 1006 corresponds to a specific frame in input video 1002 and optical flow 1004, showcasing the transformation of the windmill's motion through the application of warped noise. Result 1006 demonstrates the system's ability to maintain high per-frame image fidelity and temporal coherence, effectively translating the structured motion signals encoded in optical flow 1004 into realistic and visually consistent video content. The windmill's rotation in result 1006 closely follows the motion patterns defined by optical flow 1004, highlighting the system's capability to generate high-quality videos with precise motion control.

In some embodiments, area 1008 refers to the specific region of interest within input video 1002 that is subject to motion control. In the example of FIG. 10, area 1008 corresponds to the windmill blades, which are the primary focus of the motion dynamics. The user can define area 1008 through a user interface, specifying motion control signals such as one or more of rotation, translation, and/or scaling. These signals are used to generate synthetic optical flows, which guide the noise warping process and influence the motion dynamics of result 1006. Area 1008 enables localized motion control, allowing the system to apply precise adjustments to specific objects and/or regions within the video while preserving overall scene structure and temporal coherence.

FIG. 10 illustrates how methods of the present disclosure effectively reduce artifacts, such as the improper duplication of windmill blades, which are commonly observed in other known methods. In the depicted example, the input video features a windmill undergoing rotational motion, with the motion control guided by optical flow and warped noise generated using the disclosed processes. Unlike prior approaches that rely on manipulating activations within the diffusion model and often introduce unintended artifacts like extra windmill blades, the present methods utilize warped noise derived solely from optical flow to guide motion. By discarding structural information unrelated to motion and leveraging the Gaussianity-preserving properties of the warped noise, the disclosed methods ensure that the generated video maintains high fidelity to the intended motion while avoiding visual distortions. This demonstrates the robustness of the disclosed techniques in preserving object integrity and eliminating artifacts, even in scenarios involving complex motion dynamics.

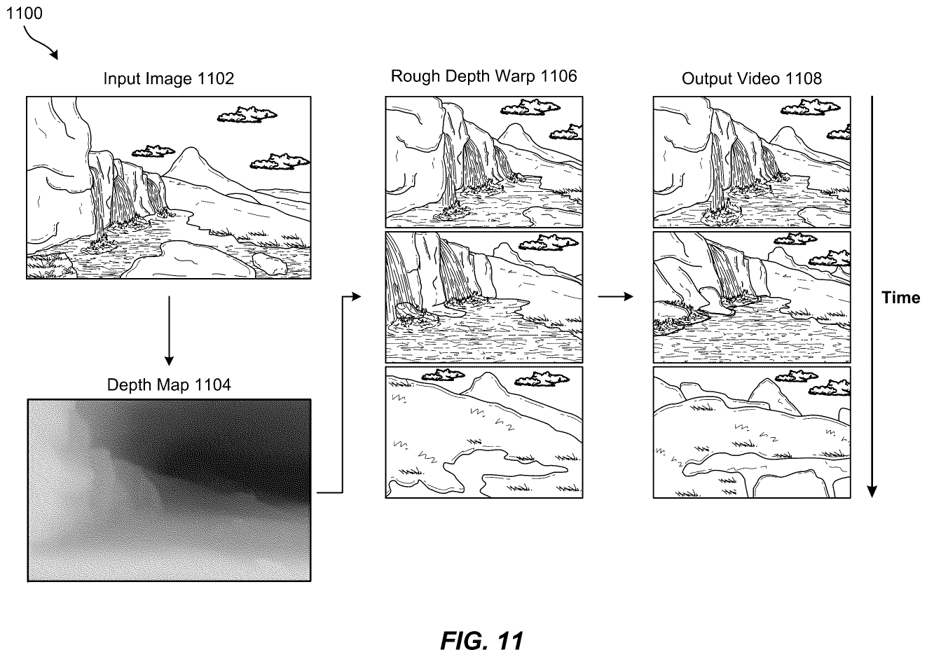

FIG. 11 is a flow diagram showing a video diffusion process 1100 that starts with generation of a depth map 1104 from an input image 1102, according to at least one embodiment of the present disclosure.

In some embodiments, video diffusion process 1100 generates a motion-controllable video from an input image 1102 by leveraging depth-based warping techniques in conjunction with video diffusion models. Accordingly, video diffusion process 1100 integrates multiple components including generation of a depth map 1104, application of a rough depth warp 1106, and production of an output video 1108 to transform static visual data into dynamic video content. In the example of FIG. 11, each component contributes to realistic motion dynamics and high-quality visual fidelity by ensuring temporal coherence and spatial consistency throughout the workflow.

In some embodiments, the input image 1102 serves as a foundational visual data for the video diffusion process 1100. Specifically, input image 1102 is a static image provided by a user or selected from a dataset, from which spatial features and visual elements defining the scene are extracted for animation. In the example of FIG. 11, the input image 1102 depicts a mountainous landscape with clouds and a river. As a result, the input image 1102 is processed to extract depth information that is necessary for generating motion dynamics and simulating camera movements. Thus, the spatial details of input image 1102 are preserved throughout the process, ensuring that output video 1108 maintains visual consistency with the original image.

In some embodiments, depth map 1104 is generated from input image 1102 using a monocular depth estimation process to encode relative distances of objects and surfaces within the scene. In some embodiments, the term “depth map” can refer to a grayscale image or the like in which lighter areas correspond to closer regions and darker areas correspond to farther regions. In the example of FIG. 11, depth map 1104 provides three-dimensionality cues that guide realistic camera movements in output video 1108. Accordingly, depth map 1104 is employed to direct rough depth warp 1106, ensuring that motion dynamics align with the spatial structure of input image 1102.

In some embodiments, rough depth warp 1106 represents an intermediate step in video diffusion process 1100, wherein depth map 1104 is used to create a preliminary video sequence by applying a crude warping process. In these embodiments, rough depth warp 1106 simulates camera translations and/or object movements based on depth information, thereby generating a sequence of frames that depict input image 1102 from varying perspectives. However, rough depth warp 1106 introduces artifacts such as pixelation and/or unnatural transitions which are subsequently addressed by the video diffusion model. Thus, rough depth warp 1106 supplies motion data for generating warped noise that serves as input to the video diffusion model.

The systems described herein perform generation of output video 1108 in a variety of ways. In some embodiments, output video 1108 is produced by initializing a video diffusion model with warped noise derived from rough depth warp 1106, followed by iterative refinement of the noisy input to yield clean, temporally coherent frames. In the example of FIG. 11, output video 1108 exhibits smooth camera movements and realistic motion dynamics, effectively translating structured motion signals from depth map 1104 and rough depth warp 1106 into high-quality video content. As a result, the mountainous landscape of input image 1102 is animated with simulated camera movement, creating a dynamic and immersive visual experience.

FIG. 12 illustrates a pixel map 1200 of two temporally adjacent pixel frames, according to at least one embodiment of the present disclosure.

Pixel map 1200 illustrates the process of noise warping between frames that can be used in motion-controllable video diffusion systems and/or methods according to the present disclosure. Pixel map 1200 is divided into two sections each corresponding to a specific frame in the video sequence. For example, the mapping of noise pixels and density values between Frame 0 and Frame 1 is achieved through forward optical flow contraction and reverse optical flow expansion as indicated by the legend. Pixel map 1200 visually demonstrates how noise values and densities are transferred and transformed during the noise warping process.

In some embodiments, source noise pixels q₀, q₁, q₂, and q3₃are located in Frame 0 and represent initial noise values before the warping process. In these embodiments, each source noise pixel is associated with a corresponding density value d₀, d₁, d₂, or d₃, which indicates the amount of noise contained within the pixel. For example, the source noise pixels are subjected to forward optical flow contraction and/or reverse optical flow expansion to determine their contribution to the destination noise pixels in Frame 1. Accordingly, the source noise pixels play a role in maintaining spatial Gaussianity during the warping process as their values are redistributed based on motion dynamics encoded in optical flow fields.

In some embodiments, during the warping process these density values of Frame 0 are used to scale and redistribute the noise contributions to the destination pixels in Frame 1. The source densities contribute to maintaining the statistical properties of Gaussian noise across frames particularly in regions undergoing contraction or expansion.

Furthermore, the destination noise pixels q′₀, q′₁, q′₂, and q′₃ are located in Frame 1 and represent the noise values after the warping process. In these embodiments, these pixels are derived from the source noise pixels q₀, q₁, q₂, and q₃in Frame 0 through forward optical flow contraction and/or reverse optical flow expansion. For example, each destination noise pixel is influenced by one or more source noise pixels depending on the motion dynamics encoded in the optical flow fields. Thus, the destination noise pixels are computed iteratively ensuring that the temporal correlations between frames are preserved while maintaining spatial Gaussianity.

In these embodiments, the destination densities d′₀, d′₁, d′₂, and d′₃ correspond to the density values of the destination noise pixels q′₀, q′₁, q′₂, and q′₃ in Frame 1. In other words, these density values indicate the amount of noise aggregated into each destination pixel during the warping process. For example, d′₂ equals 1.5, which indicates that destination pixel q′₂ has received contributions from multiple source pixels resulting in a higher density value. On the other hand, d′₁ equals 0.5, indicating that destination pixel q′₁ has received a reduced density due to expansion. Accordingly, the destination densities play a role in renormalizing the noise values to preserve Gaussianity and ensure statistical consistency across frames.

In some examples, forward optical flow represents the motion of pixels from Frame 0 to Frame 1 as indicated by the dashed arrows in pixel map 1200. In these embodiments, this flow is responsible for contracting noise pixels where multiple source pixels contribute to a single destination pixel. For example, forward optical flow maps q₂ and q₃ from Frame 0 to q′₂ in Frame 1, resulting in a higher density value d′₂ of 1.5. As a result, forward optical facilitates the redistribution of noise values based on motion dynamics.

In some embodiments, reverse optical flow represents the motion of pixels from Frame 1 back to Frame 0 as indicated by the dotted arrows in pixel map 1200. In these embodiments, this flow is responsible for expanding noise pixels where a single source pixel contributes to multiple destination pixels. For example, reverse optical flow maps q₁ from Frame 0 to q′₁ and q′₃ in Frame 1 resulting in reduced density values d′₁ of 0.5 and d′₃ of 0.5. Reverse optical flow is utilized to fill gaps in the destination frame and maintain the Gaussian distribution of noise.

Accordingly, contraction dynamics occur when multiple source noise pixels contribute to a single destination noise pixel. Conversely, expansion dynamics occur when a single source noise pixel contributes to multiple destination noise pixels. Accordingly, the process of noise warping between frames as illustrated in FIG. 12 is designed to preserve spatial Gaussianity while introducing temporal correlations. In these embodiments, this is achieved through the iterative computation of destination noise pixels and densities which account for both contraction and expansion dynamics. The preservation of Gaussianity ensures that the noise remains statistically consistent across frames enabling high-quality video diffusion with smooth and coherent motion dynamics.

Accordingly, aspects of the present disclosure contribute to the growing field of video generative models by advancing motion-controllable video generation, which has the potential to revolutionize creative industries such as filmmaking and animation. By introducing a computationally efficient and accessible framework, the disclosed systems and methods democratize high-quality video generation, enabling creators, developers, and artists to produce dynamic content with minimal resources or specialized training.

The disclosed systems and methods offer benefits in terms of efficiency and cost-effectiveness by introducing a noise warping process that operates in linear time complexity relative to the number of pixels processed. Unlike prior methods that rely on computationally expensive operations such as polygon rasterization or tracing back through multiple frames, the proposed process iteratively warps noise between temporally consecutive frames, eliminating the need for quadratic computations and reducing processing overhead. This streamlined approach enables real-time performance, making it feasible to apply noise warping during video diffusion model fine-tuning without requiring additional memory or compute resources. Furthermore, the disclosed system avoids architectural modifications to the base model, relying on fine-tuning existing model weights rather than adding new layers and/or adapters. This simplicity not only reduces training and inference costs but also ensures compatibility with modern full-attention architectures, making the solution highly scalable and accessible for diverse applications.

The following example embodiments are also included in the present disclosure:

Example 1. A computer-implemented method for motion-controllable video diffusion including: extracting optical flow fields from an input video including a plurality of frames; computing, for each frame in the plurality of frames, warped noise by iteratively warping a previous-frame noise to a current frame according to the extracted optical flow fields, wherein iteratively warping includes: re-Gaussianizing expanded pixel regions by sampling fresh Gaussian noise; and aggregating contracted pixel regions by merging noise particles and renormalizing variance to preserve spatial Gaussianity; and generating an output video by initializing a diffusion process with the warped noise and iteratively denoising to produce temporally coherent output frames.

Example 2. The computer-implemented method of Example 1, further including: receiving, via a user interface, a user-provided motion control signal to generate the input video.

Example 3. The computer-implemented method of Example 2, wherein the user-provided motion control signal includes at least one of: a bounding-box trajectory, a polygonal region translation, a depth-map warp, or an optical flow field derived from a reference video.

Example 4. The computer-implemented method of Example 2 or Example 3, wherein receiving the user-provided motion control signal includes receiving an indication of an area of an image and at least one of: a direction of movement of the area; a path of movement of the area; a rotation of the area; or a textual prompt with instructions to modify the image.

Example 5. The computer-implemented method of Example 4, wherein receiving the user-provided motion control signal further includes receiving a degradation parameter for controlling smoothness of movement in the output video.

Example 6. The computer-implemented method of any one of Examples 1 through 5, further including: applying a degradation parameter to the warped noise to form degraded warped noise based on a user-selectable degradation level; and fine-tuning a generative video diffusion model using the degraded warped noise paired with the plurality of frames as training data.

Example 7. The computer-implemented method of any one of Examples 1 through 6, wherein extracting the optical flow fields includes:
applying a neural network-based optical flow estimation algorithm to each pair of temporally adjacent frames of the plurality of frames.

Example 8. The computer-implemented method of any one of Examples 1 through 7, wherein computing the warped noise includes:
mapping pixel positions of the previous-frame noise to pixel positions of a current-frame noise based on corresponding forward and backward optical flow vectors of the extracted optical flow fields.

Example 9. The computer-implemented method of any one of Examples 1 through 8, wherein aggregating the contracted pixel regions includes: for each current-frame pixel position in the contracted pixel regions:
merging the noise particles by computing a weighted sum of the noise particles; and renormalizing the weighted sum of the noise particles to unit variance based on aggregate flow density.

Example 10. The computer-implemented method of any one of Examples 1 through 9, further including: computing, for each frame in the plurality of frames, per-pixel flow density values indicating how much noise has been compressed into a respective pixel region; and scaling the previous-frame noise to the current frame in accordance with the per-pixel flow density values to preserve the spatial Gaussianity.

Example 11. A system for motion-controllable video diffusion, the system including: a physical processor; and a memory storing instructions that, when executed by the physical processor, cause the system to: extract optical flow fields from an input video including a plurality of frames; compute, for each frame in the plurality of frames, warped noise by iteratively warping a previous-frame noise to a current frame according to the extracted optical flow fields, wherein iteratively warping includes: re-Gaussianizing expanded pixel regions by sampling fresh Gaussian noise; and aggregating contracted pixel regions by merging noise particles and renormalizing variance to preserve spatial Gaussianity; and generate an output video by initializing a diffusion process with the warped noise and iteratively denoising to produce temporally coherent output frames.

Example 12. The system of Example 11, wherein the instructions further cause the physical processor to: receive, via a user interface, a user-provided motion control signal; and generate the input video based on the user-provided motion control signal.

Example 13. The system of Example 12, wherein receiving the user-provided motion control signal includes: receiving, via the user interface, an indication of an area of an image; and receiving, via the user interface, at least one of: a direction of movement of the area, a path of movement of the area, a rotation of the area, or a textual prompt with instructions to modify the image.

Example 14. The system of Example 13, wherein the instructions further cause the physical processor to: receive, via the user interface, a degradation parameter for controlling smoothness of movement in the output video.

Example 15. The system of Example 14, wherein the instructions further cause the physical processor to: fine-tune a generative video diffusion model using the degradation parameter.

Example 16. The system of any one of Examples 11 through 15, wherein the instructions further cause the physical processor to: extract the optical flow fields by applying a neural network-based optical flow estimation algorithm to each pair of temporally adjacent frames of the plurality of frames.

Example 17. The system of any one of Examples 11 through 16, wherein the instructions further cause the physical processor to: map pixel positions of the previous-frame noise to pixel positions of a current-frame noise based on corresponding forward and backward optical flow vectors of the extracted optical flow fields.

Example 18. A non-transitory computer-readable medium including one or more computer-executable instructions that, when executed by at least one processor of a computing device, cause the computing device to: extract optical flow fields from an input video including a plurality of frames; compute, for each frame in the plurality of frames, warped noise by iteratively warping a previous-frame noise to a current frame according to the extracted optical flow fields, wherein iteratively warping includes: re-Gaussianizing expanded pixel regions by sampling fresh Gaussian noise; and aggregating contracted pixel regions by merging noise particles and renormalizing variance to preserve spatial Gaussianity; and generate an output video by initializing a diffusion process with the warped noise and iteratively denoising to produce temporally coherent output frames.

Example 19. The non-transitory computer-readable medium of Example 18, wherein the one or more computer-executable instructions further cause the computing device to: receive, via a user interface, a user-provided motion control signal; and generate the input video based on the user-provided motion control signal.

Example 20. The non-transitory computer-readable medium of Example 18 or Example 19, wherein the one or more computer-executable instructions further cause the computing device to: receive, via a user interface, a degradation parameter for controlling smoothness of movement in the output video.

As detailed above, the computing devices and systems described and/or illustrated herein broadly represent any type or form of computing device or system capable of executing computer-readable instructions, such as those contained within the modules described herein. In their most basic configuration, these computing device(s) each include at least one memory device and at least one physical processor.

In some examples, the term “memory” or “memory device” generally refers to any type or form of volatile or non-volatile storage device or medium capable of storing data and/or computer-readable instructions. In one example, a memory device can store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor can access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein can represent portions of a single module or application. In addition, in certain embodiments one or more of these modules can represent one or more software applications or programs that, when executed by a computing device, cause the computing device to perform one or more tasks. For example, one or more of the modules described and/or illustrated herein can represent modules stored and configured to run on one or more of the computing devices or systems described and/or illustrated herein. One or more of these modules can also represent all or portions of one or more special-purpose computers configured to perform one or more tasks.

In addition, one or more of the modules described herein can transform data, physical devices, and/or representations of physical devices from one form to another. Additionally or alternatively, one or more of the modules recited herein can transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various example methods described and/or illustrated herein can also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for motion-controllable video diffusion comprising:
extracting optical flow fields from an input video comprising a plurality of frames;
computing, for each frame in the plurality of frames, warped noise by iteratively warping a previous-frame noise to a current frame according to the extracted optical flow fields, wherein iteratively warping comprises:
re-Gaussianizing expanded pixel regions by sampling fresh Gaussian noise; and
aggregating contracted pixel regions by merging noise particles and renormalizing variance to preserve spatial Gaussianity; and
generating an output video by initializing a diffusion process with the warped noise and iteratively denoising to produce temporally coherent output frames.

2. The computer-implemented method of claim 1, further comprising:
receiving, via a user interface, a user-provided motion control signal to generate the input video.

3. The computer-implemented method of claim 2, wherein the user-provided motion control signal comprises at least one of: a bounding-box trajectory, a polygonal region translation, a depth-map warp, or an optical flow field derived from a reference video.

4. The computer-implemented method of claim 2, wherein receiving the user-provided motion control signal comprises receiving an indication of an area of an image and at least one of:
a direction of movement of the area;
a path of movement of the area;
a rotation of the area; or
a textual prompt with instructions to modify the image.

5. The computer-implemented method of claim 4, wherein receiving the user-provided motion control signal further comprises receiving a degradation parameter for controlling smoothness of movement in the output video.

6. The computer-implemented method of claim 1, further comprising:
applying a degradation parameter to the warped noise to form degraded warped noise based on a user-selectable degradation level; and
fine-tuning a generative video diffusion model using the degraded warped noise paired with the plurality of frames as training data.

7. The computer-implemented method of claim 1, wherein extracting the optical flow fields comprises:
applying a neural network-based optical flow estimation algorithm to each pair of temporally adjacent frames of the plurality of frames.

8. The computer-implemented method of claim 1, wherein computing the warped noise comprises:
mapping pixel positions of the previous-frame noise to pixel positions of a current-frame noise based on corresponding forward and backward optical flow vectors of the extracted optical flow fields.

9. The computer-implemented method of claim 1, wherein aggregating the contracted pixel regions comprises:
for each current-frame pixel position in the contracted pixel regions:
merging the noise particles by computing a weighted sum of the noise particles; and
renormalizing the weighted sum of the noise particles to unit variance based on aggregate flow density.

10. The computer-implemented method of claim 1, further comprising:
computing, for each frame in the plurality of frames, per-pixel flow density values indicating how much noise has been compressed into a respective pixel region; and
scaling the previous-frame noise to the current frame in accordance with the per-pixel flow density values to preserve the spatial Gaussianity.

11. A system for motion-controllable video diffusion, the system comprising:
a physical processor; and
a memory storing instructions that, when executed by the physical processor, cause the system to:
extract optical flow fields from an input video comprising a plurality of frames;
compute, for each frame in the plurality of frames, warped noise by iteratively warping a previous-frame noise to a current frame according to the extracted optical flow fields, wherein iteratively warping comprises:
re-Gaussianizing expanded pixel regions by sampling fresh Gaussian noise; and
aggregating contracted pixel regions by merging noise particles and renormalizing variance to preserve spatial Gaussianity; and
generate an output video by initializing a diffusion process with the warped noise and iteratively denoising to produce temporally coherent output frames.

12. The system of claim 11, wherein the instructions further cause the physical processor to:
receive, via a user interface, a user-provided motion control signal; and
generate the input video based on the user-provided motion control signal.

13. The system of claim 12, wherein receiving the user-provided motion control signal comprises:
receiving, via the user interface, an indication of an area of an image; and
receiving, via the user interface, at least one of: a direction of movement of the area, a path of movement of the area, a rotation of the area, or a textual prompt with instructions to modify the image.

14. The system of claim 13, wherein the instructions further cause the physical processor to:
receive, via the user interface, a degradation parameter for controlling smoothness of movement in the output video.

15. The system of claim 14, wherein the instructions further cause the physical processor to:
fine-tune a generative video diffusion model using the degradation parameter.

16. The system of claim 11, wherein the instructions further cause the physical processor to:
extract the optical flow fields by applying a neural network-based optical flow estimation algorithm to each pair of temporally adjacent frames of the plurality of frames.

17. The system of claim 11, wherein the instructions further cause the physical processor to:
map pixel positions of the previous-frame noise to pixel positions of a current-frame noise based on corresponding forward and backward optical flow vectors of the extracted optical flow fields.

18. A non-transitory computer-readable medium comprising one or more computer-executable instructions that, when executed by at least one processor of a computing device, cause the computing device to:
extract optical flow fields from an input video comprising a plurality of frames;
compute, for each frame in the plurality of frames, warped noise by iteratively warping a previous-frame noise to a current frame according to the extracted optical flow fields, wherein iteratively warping comprises:
re-Gaussianizing expanded pixel regions by sampling fresh Gaussian noise; and
aggregating contracted pixel regions by merging noise particles and renormalizing variance to preserve spatial Gaussianity; and
generate an output video by initializing a diffusion process with the warped noise and iteratively denoising to produce temporally coherent output frames.

19. The non-transitory computer-readable medium of claim 18, wherein the one or more computer-executable instructions further cause the computing device to:
receive, via a user interface, a user-provided motion control signal; and
generate the input video based on the user-provided motion control signal.

20. The non-transitory computer-readable medium of claim 18, wherein the one or more computer-executable instructions further cause the computing device to:
receive, via a user interface, a degradation parameter for controlling smoothness of movement in the output video.
